(19) United States
(12) Patent Application Publication
(10) Pub. No.: US 2006/0145994 A1
(43) Pub. Date: Jul. 6, 2006

(54) Display system with impending failure indicator

(75) Inventors: Hjalmar Edzer Ayco Huitema, Eindhoven (NL); Bas Jan Emile Van Rens, Eindhoven (NL); Gerwin Hermanus Gelinck, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/560,007

(22) PCT Filed: Jun. 15, 2004
(86) PCT No.: PCT/IB04/50903

§ 371 Date: Dec. 8, 2005

(30) Foreign Application Priority Data
Jun. 19, 2003 (EP) 03101800.5

(51) Int. Cl. G09G 3/36

(52) U.S. Cl. 345/98

(57) ABSTRACT

A display system is provided with means to determine (14,15) and to display a remaining lifetime or other physical properties of a display device of said display system to signal the need for replacement.

The invention relates to a display system comprising at least one display device with a multiple of picture elements and having means for applying driving voltages to said picture elements.

The invention further relates to a display device for such a system and a handheld electronic device.

The display device is for instance a (active matrix) liquid crystal display device (AMLCD). In an active matrix liquid crystal display device driving voltages are applied to said picture elements via thin film transistors.

Such display devices e.g. electrophoretic devices or liquid crystal devices have found widespread use in the computer industry and in handheld devices ranging from mobile telephones and price tags to palm top computers and organizers. The invention particularly relates to the use of flexible (plastic) substrates in such displays. Such flexible (plastic) substrates provide an attractive alternative for portable display devices, since plastic substrates lower the display weight, while making it more robust and flexible.

However at this moment the lifetime of the display devices on plastic substrates is much shorter than the lifetime of the display devices on glass. It is caused mainly by the porous nature of the plastic substrates. One of the lifetime problems in the active matrix display devices is the reduction of the on current and increase of the off current (the leakage current) in the thin film transistors that drive the picture elements. This can be caused be several underlying mechanisms, such as reduction of the carrier mobility or increase of the doping level in the semiconductor material or a shift in the threshold voltage. The change in the on—current as well as the off—current reduces the contrast ratio of the picture elements and may eventually cause the end-of-life of the display device.

Further degradation mechanisms having effect on the lifetime of the display devices on plastic include tearing, creasing, folding or perforating the display (substrate). The common feature of these degradation mechanisms is that some row or column lines in the display will contain ‘opens’.

One generally adopted approach is to accept a reduced lifetime and make cheap, disposable displays that can be connected to a non-disposable application device, as described in European Application No. 02077457 (PH-NL 02.0536). One problem in such applications is the need for the user to determine a moment at which the disposable display has to be replaced. This implies making the user alert to be aware of the progress towards end-of-life of a display device by a displayed (or e.g. audible) indication. A further related, problem is how to measure the general status of the display with respect to end-of-life due to accelerated local degradation mechanisms, such as malfunctions resulting from local tearing, creasing, folding or perforating the display.

It is one of the objects of the present invention to overcome at least partly the above-mentioned problems. To this end a display system according to the invention has an indicator to indicate an impending failure of the displays. In particular it is able to display a remaining lifetime, e.g. by measuring and relating a physical property of said display device to the display lifetime.

By relating the actual value of said physical property to a known (predicted) display lifetime a status indication is obtained.

As mentioned above the physical property of said display device may be a mechanical or constructional property or a property of the driving means for applying driving voltages to said picture elements.

The means for relating a physical property of the display device to the display lifetime may comprise measurement of currents or capacitances.

The status indication may either be part of the display or it may be activated at a separate place by means of a push bottom or remote control.

These and other aspects of the invention are apparent from and will be elucidated with reference to the embodiments described hereinafter.

In the drawings:

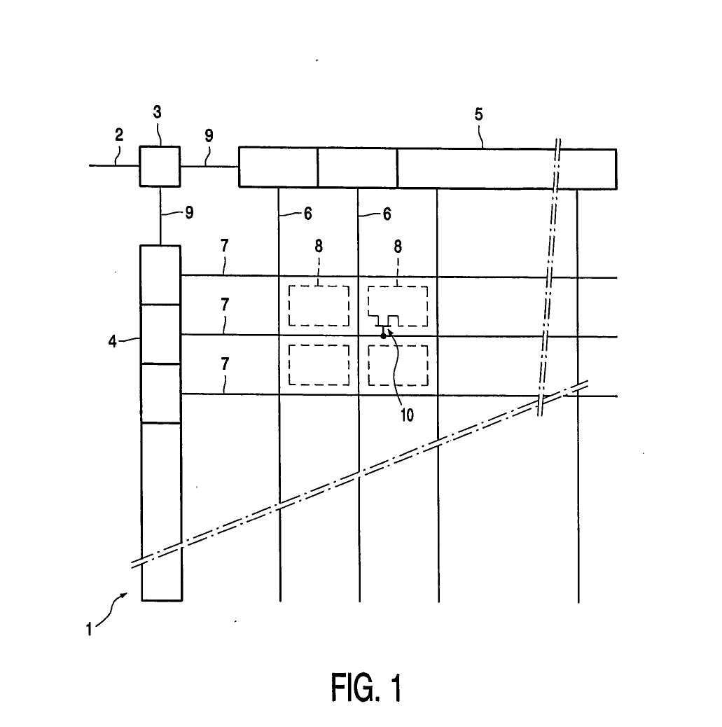

FIG. 1 schematically shows a (liquid crystal) display device,

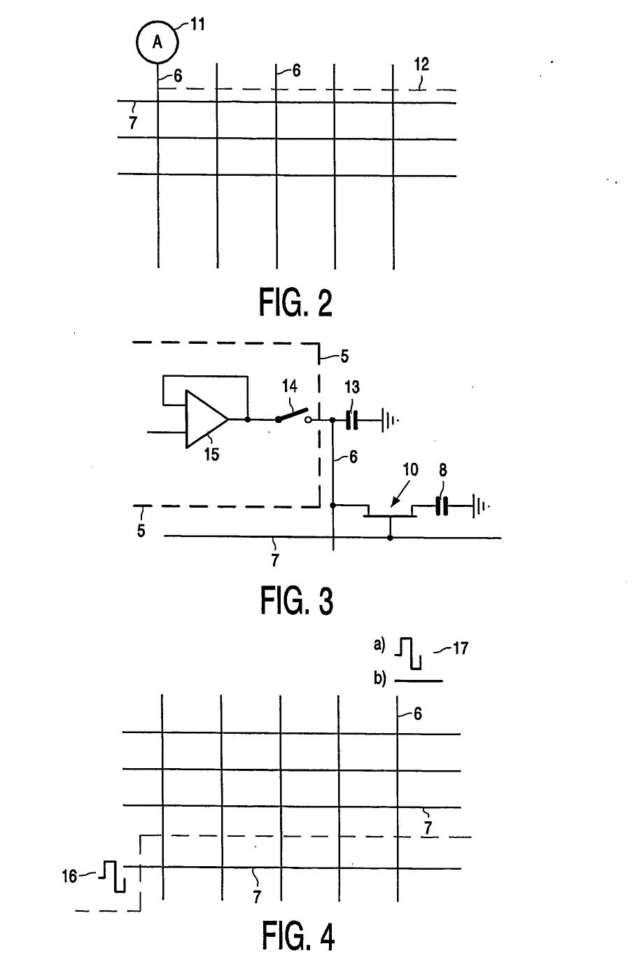

FIG. 2 schematically shows a way of measuring the current flowing to or from the picture elements in a device according to the invention, while

FIG. 3 shows a further detail of FIG. 2 and

FIG. 4 schematically shows a way of measuring the quality of a (liquid crystal) display device in a device according to the invention.

The Figures are diagrammatic and not drawn to scale. Corresponding elements are generally denoted by the same reference numerals.

FIG. 1 is an electric equivalent circuit diagram of a part of a display device 1 to which the invention is applicable. It comprises in one possible embodiment (one mode of driving, called the “passive mode”) a matrix of picture elements 8 defined by the areas of crossings of row or selection electrodes 7 and column or data electrodes 6. The row electrodes are consecutively selected by means of a row driver 4, while the column electrodes are provided with data via a data register 5. To this end, incoming data 2 are first processed, if necessary, in a processor 3. Mutual synchronization between the row driver 4 and the data register 5 takes place via drive lines 9.

In another possible embodiment (another mode of driving, called the “active mode”) signals from the row driver 4 select the picture electrodes via thin-film transistors (TFTs) 10 whose gate electrodes are electrically connected to the row electrodes 7 and the source electrodes are electrically connected to the column electrodes. The signal, which is present at the column electrode 6, is transferred via the TFT to a picture electrode of a picture element 8 coupled to the drain electrode. The other picture electrodes are connected to, for example, one (or more) common counter electrode(s). In FIG. 1 only one thin film transistor (TFT) 10 has been drawn, simply as an example.

Some of the lifetime problems in such active matrix are reduction of the on current and increase of the off current (the leakage current) in the TFT's 10 that drive the picture elements 8. This can be caused be several underlying mechanisms, such as reduction of the carrier mobility or increase of the doping level in the semiconductor material or a shift in the threshold voltage. The changes in the on current as well as the off current reduce the contrast ratio of the picture elements and can eventually cause the end-of-life of the display.

Monitoring of the on current or the off current of the TFT's 10 preferably is done in TFT's driving picture elements since their status most closely reflects the use (and consequently the lifetime) of the TFT's. Monitoring of these currents can be done by measuring the current flowing to or from the picture elements through one or more columns in the display, as shown in FIG. 2, which shows a current meter 11 attached to one of the columns 6. The number of columns attached to the current meter 11 can be enhanced, as shown by the dashed line 12, to improve the accuracy of the measurement.

Current measurement can be easily implemented without major changes to the drive circuitry, using the circuitry as shown in FIG. 3. As a sampling capacitor an additional capacitor 13 is used although the intrinsic capacitance of the column electrode 6 can also be used. The voltage on the column electrode 6 after a certain sampling time is then a measure of the on current or the off current of the TFT's.

The picture elements 8 are driven when the drive/measure switch 14 connects the column electrode 6 with the operational amplifier 15. When the switch 14 is open, the average current (1) during a certain sampling time (t) can be measured at the capacitor 13. The voltage over the capacitor at the end of the sampling time is related to the average current by: I=CV/t.

This method can easily be implemented in a driver, as it does not require timing periods different from the frame time or the line time and it does not require an additional capacitor. The measurement can be carried out in any part of the display. It only requires a measurement period of at most 300 milliseconds (comparable to the switching time of most display effects). The driver may be part of the display device or part of the display system comprising said display device.

The status of the active-matrix display with respect to end-of-life, due to TFT-lifetime is directly related to the measured column voltage. The lower the measured column voltage the closer the display device is to its end-of-life condition.

The on current of the TFT's 10 (e.g. p-type TFT's) is measured in this example by first charging all picture elements related to a column electrode 6 to a reference voltage (+5V in this example). Then the TFT's 10 are closed while the drive/measure switch 14 (FIG. 3) is opened up to (a few times) the line time (smaller than 200 microseconds). After a certain period t₁ the gate is opened again. This pulls down the column voltage by capacitive coupling. The column electrode is then charged by the picture elements. Detection of the picture element voltage at t₁ can now be performed by measuring the column voltage at a measuring time tₘₑₐₛ. The latter timing is not critical since a steady state column voltage is reached as determined by the ratio of the total column capacitance to the total picture element capacitance.

When n-type TFT's are used the measurement method remains the same, but the voltages on the gate line are reversed.

The off current of the TFT's 10 (e.g. p-type TFT's) is measured in this example by first charging all picture elements related to a column electrode 6 to a reference voltage (+5V in this example). Then the gates are closed while the voltage on the column electrode is set to 0 V and the drive/measure switch 14 remains closed. After a frame time (20 ms) the picture element voltage has decreased, depending on the off current of the TFT's 10. In the last stage (beyond 20 milliseconds) the drive/measure switch 14 and the TFT's 10 are opened. Opening of the TFT's pulls down the column voltage by capacitive coupling. The column is then charged by the picture elements. Measuring the column voltage at a measuring time tₘₑₐₛ performs detection of the off current of the TFT's. Again this timing is not critical since a steady state column voltage is reached that is determined by the ratio of the total column capacitance to the total picture element capacitance.

In certain types of displays based on e.g. liquid crystal effects, electrophoretic effects or some emissive display effects picture elements can be considered as a capacitor. In this case the capacitance of the picture elements can be monitored. The capacitance of the picture elements for instance changes when the composition of the display material changes, which may be due to the porous nature of plastic substrates. The capacitance measurement can also be used very well for the problem of ‘black spots’ in plastic LCD displays. These black spots appear after some time and contain gas. The pixels containing the gas appear as black pixels, because they cannot be switched anymore. The capacitance of such pixels will be very different from that of normal pixels.

FIG. 4 shows schematic drawing of a display device where a signal 16 (e.g. a block pulse) is applied to a row electrode 7 and a (not shown) detector is connected to a column electrode 6. The signal 16 reaches the crossing between the row and the column and a signal 17^{a} is detected due to capacitive row-column coupling, including the capacitance of the picture element. The voltage of the signal 17^{a} is related to the capacitance of the picture element, and consequently to the lifetime of the picture element. If the line is broken due to degradation mechanisms, no signal can be detected on the column (signal 17^{b}). These degradation mechanisms may include tearing, creasing, folding or perforating the display device. The common feature of these degradation mechanisms is that some row or column lines in the display will contain ‘opens’ after one of the degradation mechanisms has manifested itself. The method for measuring the on current in active-matrix displays described above may alternatively be used.

Another parameter, which may be measured, is the voltage holding capacity of the display effect, which is closely related to the resistivity of the material. During use it may decrease, especially in plastic displays, due to for instance ionic impurities that diffuse into the display. The voltage holding ratio can be measured with a method similar to the one presented above for measuring the off current.

Other electrical parameters can also be selected for the end-of-life condition. In general the measurement method consists of (1) biasing selected rows or columns, and relate the response to the end-of-life condition, (2) recording the change in optical response upon known electrical stimuli, and (3) relate this to the end-of-life condition, e.g. by using the procedure for measuring the on and off current as described above, if necessary with dedicated TFT's.

The results of the measurements may be displayed in the display or in the apparatus comprising the display and may indicate the expected time until the end of life of the display. Additionally, a warning may be displayed when the display quality drops below a predefined percentage of the starting quality. The expected time generally is determined by lifetime tests.

If the lifetime of the display is largely determined by the amount of time the display has been removed from its package and clicked onto the electronic device the lifetime passed is defined as the time the display is removed from the packaging and the maximum lifetime is defined as the maximum time the display can be removed from the packaging before the display quality becomes too poor then the percentage of display life that will be displayed is calculated, for instance by using the formula: Percentage left=100%*(1−lifetime passed/maximum lifetime). This can be used for e.g. all types of flexible displays (LCD, OLED, electrophoretic, etcetera) where the degradation is governed by permeation through the plastic substrates.

If the amount of time the display is switched on and actually displaying an image determines said lifetime the percentage would be computed for instance by: Percentage left=100%*(1−operational time passed/maximum operational time). This method can be useful for (flexible) (O)LED displays where the degradation is governed by the number of hours the polymer LEDs have been emitting light.

It should be noted that in an actual display a combination of degradation mechanisms will be present and therefore it is advantageous to use a combination of a number of these methods. The measurements can be performed when the display is turned on or off or by adding a special button that can be pressed by a user or when the display goes out of a sleep mode. The advantage of that button in bi-stable displays, like electrophoretic displays, is that it can be used as an erase button as well. Instead of indicating the display status visibly, (audible) sounds may be used to warn a user for impending of the display.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. Display system comprising at least one display device (1) the display system having an indicator to indicate an impending failure of the display device.

2. A display device according to claim 1, the display system comprising means for measuring a physical property of said display device (1) and means for comparing the value of the measured physical property to a reference value and, dependent on the result of the comparison, actuating the indicator.

3. A display according to claim 1 in which the indicator displays remaining lifetime.

4. A display system according to claim 2 in which the physical property of said display device is a mechanical property.

5. A display system according to claim 2 in which the physical property of said display system is a property of said driving means for having driving means (4,5) for applying driving voltages to picture elements (8).

6. A display system according to claim 5 in which the property of said driving means is an electrical property of thin film transistors (10).

7. A display system according to claim 2 in which the means for relating a physical property of said display device to the display lifetime comprise current measurement.

8. A display system according to claim 2 in which the means for relating a physical property of said display device to the display lifetime comprise a capacitive measurement.

9. A display system according to claim 1, the display device being replaceable.

10. A display system according to claim 9, the display device being bendable, foldable or rollable.

11. A display device being capable to be integrated in a display system according to claim 1.

12. A handheld electronic device comprising a display system according to claim 1.
